(19) United States
(12) Patent Application Publication
(10) Pub. No.: US 2011/0272263 A1
(43) Pub. Date: Nov. 10, 2011

(54) METAL DOME SHEET COMPRISING CONDUCTIVITY SHEET

(75) Inventors: Min-Ju Lee, Yongin-si (KR); Min-Seok Kim, Yongin-si (KR); Jung-Woo Kim, Suwon-si (KR); Min-Hwan Jeon, Yongin-si (KR)

(73) Assignee: SAMSUNG ELECTRONICS CO., LTD., Suwon-si (KR)

(21) Appl. No.: 13/100,196

(22) Filed: May 3, 2011

(30) Foreign Application Priority Data
May 4, 2010 (KR) 10-2010-0041705

(51) Int. Cl. H01H 13/76; B32B 15/04; B32B 15/00

(52) U.S. Cl. 200/5 A; 428/615; 428/457

(57) ABSTRACT

The keypad assembly uses a metal dome sheet that shields electromagnetic waves and noise. A metal dome is placed on a base sheet. And a conductive sheet is placed above the base sheet to shield electromagnetic waves and noise.

### CROSS-REFERENCE TO RELATED APPLICATION AND CLAIM OF PRIORITY

The present application is related to and claims the benefit under 35 U.S.C. §119(a) of a Korean patent application filed in the Korean Intellectual Property Office on May 4, 2010 and assigned Serial No. 10-2010-0041705, the contents of which are herein incorporated by reference.

### TECHNICAL FIELD OF THE INVENTION

The present invention relates to a metal dome sheet. More particularly, the present invention relates to a metal dome sheet for shielding an electromagnetic wave or noise.

### BACKGROUND OF THE INVENTION

With the development of electronics among communication industries in recent years, an electronic apparatus such as a mobile communication terminal, an electronics organizer, a Personal Digital Assistant (PDA), and such, has become necessities of modern life. Thus, the electronic apparatus has become an important means for information delivery in a fast-changing information environment. In such a situation, ever since a regulation for Electronic Magnetic Interference (EMI) took effect, research and development on EMI/Electro Magnetic Compatibility (EMC) has been underway. Consequently, the electronic apparatus has become smaller in size and higher in quality.

The electronic apparatus may radiate a part of electronic energy used inside the apparatus through an ambient space or a power line. In some situations, a system may malfunction or a throughput may not be as high as expected under the influence of emitted energy. Such a problem is called electromagnetic noise (hereinafter, simply referred to as noise). The noise is generated by an unnecessary electrical signal among electrical signals flowing through an electronic circuit. In addition, because the electronic apparatus as well as a mobile communication apparatus has been widely used and a frequency band in use has increased, a noise problem has become a social issue. Therefore, there is an effort to solve this problem. Although a method of restricting noise generation seems to be the best, there is a difficulty in dealing with the problem due to overloads caused by the noise generation.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide a metal dome sheet comprising a conductive sheet for shielding an electromagnetic wave and noise.

In accordance with an aspect of the present invention, a metal dome sheet that includes a conductive sheet is provided. The metal dome sheet includes a base sheet and a conductive sheet. A metal dome is placed on the base sheet. And the conductive sheet is placed above the base sheet to shield an electromagnetic wave or noise.

In accordance with another aspect of the present invention, a keypad assembly is provided. The keypad assembly includes a transparent or translucent keypad that includes a key button. A light guide sheet is placed below the keypad and induces a light beam of a light source to deliver the light beam to the keypad. A conductive sheet is placed below the light guide sheet. A base sheet is placed below the conductive sheet and includes a metal dome corresponding to the key button. And a substrate, where the base sheet is attached, provides the light source and generates an electrical contact when the metal dome is pressed.

In accordance with yet another aspect of the present invention, an input device is provided. The input device includes a Printed Circuit Board (PCB) and a conductive sheet. The PCB includes a metal dome and generates an electrical contact when the metal dome is pressed. The conductive sheet is placed above the PCB to shield an electromagnetic wave or noise.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portable terminal employing a keypad assembly that uses a metal dome sheet comprising a conductive sheet according to an embodiment of the present invention;

FIG. 2 illustrates a cross-sectional view for a structure of a metal dome sheet that includes a conductive sheet according to an embodiment of the present invention; and

FIG. 3 illustrates a cross-sectional view for a structure of a keypad assembly that uses a metal dome sheet that includes a conductive sheet according to an embodiment of the present invention.

### DETAILED DESCRIPTION OF THE INVENTION

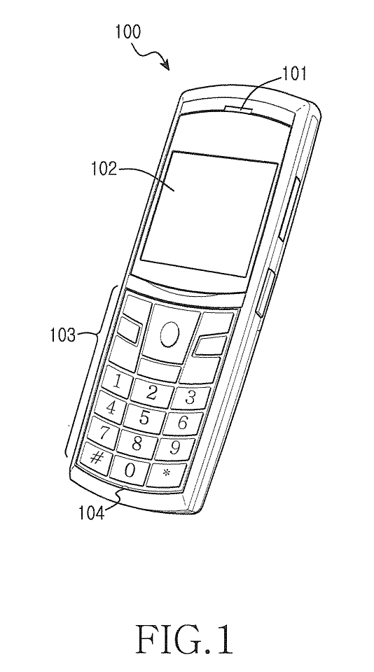

FIGS. 1-3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention relates to a metal dome sheet. More particularly, the present invention relates to a metal dome sheet for shielding an electromagnetic wave or noise.

FIG. 1 illustrates a portable terminal employing a keypad assembly that uses a metal dome sheet comprising a conductive sheet according to an embodiment of the present invention.

In the description of the present invention, a bar type portable wireless terminal illustrated in FIG. 1 will be used to explain a structure proposed in the present invention. However, the present invention is not limited thereto, and thus is also applicable to another type (e.g., a folder type, a slide type, and such) of the portable wireless terminal that does not from the spirit of the present invention. In addition, the metal dome sheet according to an embodiment of the present invention is also applicable to an electronic apparatus such as a television set, a camcorder, and such.

Referring to FIG. 1, a portable wireless terminal 100 includes a speaker 101 that outputs a voice signal and a display 102 that is located below the speaker 101 to output a video signal. Furthermore, the portable wireless terminal 100 includes a key assembly 103 that is a data input element and a microphone 104 that is located below the key assembly 103 to input the voice signal. The display 102 may be a Liquid Crystal Display (LCD) that includes millions of pixels.

In particular, according to the present invention, the key assembly 103 of the portable wireless terminal 100 includes a conductive sheet for shielding an electromagnetic wave or noise.

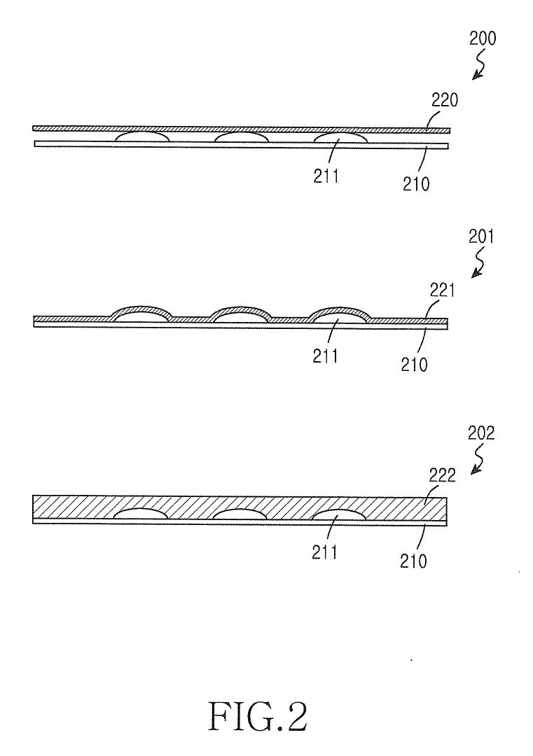

FIG. 2 illustrates a cross-sectional view for a structure of a metal dome sheet that includes a conductive sheet according to an embodiment of the present invention.

Referring to FIG. 2, metal dome sheets 200, 201, and 202 comprising the conductive sheet according to an embodiment of the present invention include base sheets 210, on which a metal dome is placed, and conductive sheets 220, 221, and 222 laminated above the base sheets 210.

The base sheet 210 is attached to a proper position of a Printed Circuit Board (PCB). An electrical contact is generated on the PCB when the metal dome 211 of the base sheet 210 is pressed. The conductive sheets 220, 221, and 222 shield a harmful electromagnetic wave from outside, and thus the PCB is not interfered. In addition, the conductive sheet 220 may shield noise generated when the metal dome 211 of the base sheet 210 is pressed. Furthermore, the conductive sheets 220, 221, and 222 may shield noise, generated in a unit (e.g., a speaker, and such) placed on the PCB. Moreover, the conductive sheets 220, 221, and 222 may be used as a ground by being electrically connected to the PCB. The conductive sheets 220, 221, and 222, as a ground, may attenuate the noise. For example, when the metal dome is pressed, an electrical contact may be generated, and noise may also be generated occasionally. In this situation, the conductive sheets 220, 221, and 222 used as the ground may attenuate the generated noise.

The conductive sheet may have various shapes. As illustrated in FIG. 2, the first conductive sheet 220 is placed above the metal dome 211. The second conductive sheet 221 and the third conductive sheet 222 cover the metal dome 211. The conductive sheets 220, 221, and 222 may be placed above the base sheet 210 by coating or applying a specific material.

Furthermore, by using a flexible conductive material, the conductive sheets 220, 221, and 222 may be restored together when the metal dome is restored after being pressed. In addition, the conductive sheets 220, 221, and 222 may use a specific insulation sheet to insulate the base sheet 210 and the metal dome. For example, the conductive sheets 220, 221, and 222 may be attached to the base sheet 210 by means of an acrylic adhesive or an epoxy adhesive. When the conductive sheets 220, 221, and 222 are used as a ground, they may not necessarily be insulated from the metal dome 211 of the base sheet 210. However, it may be necessary to process signals according to simultaneously pressed metal domes.

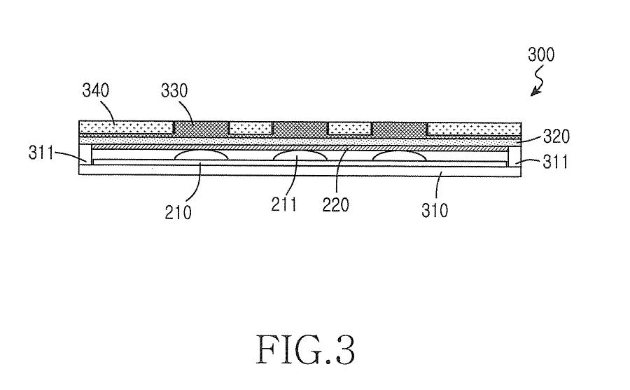

FIG. 3 illustrates a cross-sectional view for a structure of a keypad assembly that uses a metal dome sheet that includes a conductive sheet according to an embodiment of the present invention.

Referring to FIG. 3, a keypad assembly 300 includes a substrate 310, a metal dome sheet 200 attached to the substrate 310, a keypad 330 that includes a key button for pressing a metal dome 211 of the metal dome sheet 200, and a case frame 340 for defining an outer surface and for exposing the key button by inserting the keypad 330. In addition, the keypad assembly 300 may further include a light guide sheet 320 disposed between the keypad 330 and the metal dome sheet 200. The light guide sheet 320 induces a light beam from a light source 311 of the substrate (or PCB) 310 to illuminate the keypad 330.

The substrate 310 includes a conductive layer that includes a contact portion in which an electrical contact is generated when the metal dome 211 of the metal dome sheet 200 is pressed and a frame placed below the conductive layer. The frame may be a PCB (Printed Circuit Board) or a Flexible PCB (FPCB). In addition, the substrate 310 may include the light source 311 that illuminates the keypad placed on an upper side. The light source 311 may be a Light Emitting Diode (LED).

The metal dome sheet 200 according to the example embodiment of the present invention includes a base sheet 210, on which at least one or more metal domes 211 are placed, and a conductive sheet 220 attached above the base sheet 210. As described above, the conductive sheet 220 shields a harmful electromagnetic wave from outside, and thus the substrate 310 is not interfered. In addition, the conductive sheet 220 may shield noise that may be generated when the dome of the base sheet 210 is pressed. Furthermore, the conductive sheet 220 may shield noise that may be generated in a unit (e.g., a speaker, and such) placed on the substrate 310. Moreover, the conductive sheet 220 may be used as a ground by being electrically connected to the substrate 310. Herein, the base sheet 210 is excellent in terms of an insulating property, a heat-resistant property, a cold-resistant property, a chemical-resistant property, and an abrasion-resistant property, and can be provided with a thin and flexible polyimide film. The metal dome sheet 200 may be attached to the substrate 310 by means of an acrylic adhesive or an epoxy adhesive.

As described above, the light guide sheet 320 induces a light beam emitted from the light source 311 of the substrate 310 such that the keypad 300 placed on an upper side has a specific brightness. In an embodiment, the keypad 330 may be transparent or translucent.

In particular, the conductive sheet 220 of the metal dome sheet 200 is formed with a conductor that can reflect a light beam, and may allow the light beam introduced by the light guide sheet 320 to be illuminated more to the keypad 330. For example, the conductive sheet 220 may form with metal with a high reflection rate, such as copper, silver, gold, and such.

In addition, the keypad 330, the light guide sheet 320, and the conductive sheet 220 have an elastic property, and thus may be restored after the key button is pressed.

The present invention may be applied to an input device using a metal dome. The input device according to an embodiment of the present invention may include a PCB which includes a metal dome and generate an electrical contact when the metal dome is pressed and a conductive sheet is placed above the PCB to shield an electromagnetic wave or noise.

In addition, the light guide sheet that induces the light beam of the light source and delivers the light beam to the keypad may have a conductive layer thin film that shields the electromagnetic wave or noise. That is, the light guide sheet that includes the conductive layer thin film on a lower side may be laminated above the PCB on which the metal dome is placed. The conductive layer thin film may be an attachable sheet or may be coated or applied with a specific conductive material.

Accordingly, a metal dome sheet that includes a conductive sheet according to embodiments of the present invention may shield an electromagnetic wave or noise.

Although the present disclosure has been described with an embodiment, various changes and modifications may be suggested to one skilled in the art. It is intended that the present disclosure encompass such changes and modifications as fall within the scope of the appended claims.

What is claimed is:

1. A metal dome sheet that includes a conductive sheet, the metal dome sheet comprising:
a base sheet on which a metal dome is placed; and
a conductive sheet placed above the base sheet and configured to shield at least one of an electromagnetic wave and noise.

2. The metal dome sheet of claim 1, wherein the base sheet and the conductive sheet are insulated from each other.

3. The metal dome, sheet of claim 1, wherein the base sheet and the conductive sheet are attached to each other by one of an acrylic adhesive and an epoxy adhesive.

4. The metal dome sheet of claim 1, wherein the conductive sheet has an elastic recovery force.

5. The metal dome sheet of claim 1, wherein the conductive sheet comprises a silver foil.

6. A keypad assembly comprising:
a keypad comprising a key button;
a light guide sheet placed below the keypad and configured to induce a light beam of a light source to deliver the light beam to the keypad;
a conductive sheet placed below the light guide sheet;
a base sheet placed below the conductive sheet and comprising a metal dome corresponding to the key button; and
a substrate, where the base sheet is attached, configured to provide the light source and generate an electrical contact when the metal dome is pressed.

7. The keypad assembly of claim 6, wherein the conductive sheet is configured to reflect the light beam induced by the light guide sheet to the keypad.

8. The keypad assembly of claim 7, wherein the conductive sheet and the base sheet are insulated from each other.

9. The keypad assembly of claim 7, wherein the conductive sheet has an elastic recovery force.

10. The keypad assembly of claim 7, wherein the substrate comprises one of a Printed Circuit Board (PCB) and a Flexible PCB (FPCB).

11. The keypad assembly of claim 7, wherein the conductive sheet is attached below the light guide sheet.

12. The keypad assembly of claim 7, wherein the conductive sheet is attached above the base sheet.

13. The keypad assembly of claim 7, wherein the conductive sheet is electrically connected to the substrate and is configured to be used as a ground.

14. The keypad assembly of claim 7, wherein the conductive sheet comprises a silver foil.

15. The keypad assembly of claim 6, wherein the base sheet and the conductive sheet are attached to each other by one of an acrylic adhesive and an epoxy adhesive.

16. The keypad assembly of claim 6, wherein the keypad further comprises one of a transparent and translucent attribute.

17. An input device comprising:
a Printed Circuit Board (PCB) comprising a metal dome and configured to generate an electrical contact when the metal dome is pressed; and
a conductive sheet placed above the PCB and configured to shield at least one of an electromagnetic wave and noise.

18. The input device of claim 17, wherein the conductive sheet is insulated from the metal dome.

19. The input device of claim 17, wherein the conductive sheet is electrically connected to the PCB and is configured to be used as a ground.

20. The input device of claim 17, wherein the conductive sheet has an elastic recovery force.
